(19) United States
(12) Patent Application Publication
(10) Pub. No.: US 2009/0221366 A1
(43) Pub. Date: Sep. 3, 2009

(54) CONFIGURATION OF A GAMING DEVICE

(76) Inventors: Matthew J. Ward, Northbrook, IL (US); Brandon Estes, Chicago, IL (US); Jorge Luis Shimabukuro, Las Vegas, NV (US); Timothy D. Wilson, Oak Park, IL (US); Peter R. Anderson, Glenview, IL (US); Dale R. Buchholz, Palatine, IL (US); Srinivyasa M. Adiraju, Vernon Hills, IL (US)

Correspondence Address: SCHWEGMAN, LUNDBERG & WOESSNER/WMS GAMING, P.O. BOX 2938, MINNEAPOLIS, MN, 55402, US

(21) Appl. No.: 11/995,890

(22) PCT Filed: Jul. 20, 2006
(86) PCT No.: PCT/US06/28250

§ 371 Date: Dec. 8, 2008

Related U.S. Application Data
(60) Provisional application No. 60/700,825, filed on Jul. 20, 2005.

(51) Int. Cl. A63F 13/00; A63F 9/24

(52) U.S. Cl. 463/30; 463/42

(57) ABSTRACT

Methods and apparatus for configuration of a gaming device are described herein. In one embodiment, the method includes receiving configuration information associated with a specific gaming machine. The method can also include, based at least in part on the configuration information, determining configuration settings and obtaining values for the configuration settings. The method can also include transmitting the values for use in configuring the specific gaming machine.

### RELATED APPLICATIONS

This application claims the priority benefit of U.S. Provisional Application Ser. No. 60/700,825 filed Jul. 20, 2005, the content of which is incorporated herein by reference.

### FIELD

This invention relates generally to the field of wagering game machines and more particularly to the field of wagering game machine configuration.

### COPYRIGHT

A portion of the disclosure of this patent document contains material to which the claim of copyright protection is made. The copyright owner has no objection to the facsimile reproduction by any person of the patent document or the patent disclosure, as it appears in the U.S. Patent and Trademark Office file or records, but reserves all other rights whatsoever. Copyright 2006, WMS Gaming, Inc.

### BACKGROUND

### Description of Related Art

A wide variety of computerized wagering game machines (a.k.a. gaming machines) are now available to casino operators and players. Computerized gaming machines range from slot machines to games that are traditionally played live, such as poker, blackjack, roulette, etc. These computerized gaming machines provide many benefits to game owners and players, including increased reliability over mechanical machines, greater game variety, improved sound and animation, and lower overall management cost.

When technicians initially deploy gaming machines for use in casinos, they typically manually wire the gaming machines into gaming networks and manually configure numerous gaming machine settings. For example, the technicians may configure settings such as currency denominations for bill validators, screen resolution for video displays, volume for an audio devices, etc. Additionally, the technicians may also configure wagering game settings, such as pay lines, jackpot limits, betting limits, bonus game settings, and the like. Technicians traditionally configure gaming machine settings by toggling DIP switches, moving expansion board jumpers, setting various dials and knobs, and paging through complicated set-up menus. As a result, manually configuring gaming machines on the casino floor can be an expensive and laborious process.

### BRIEF DESCRIPTION OF THE FIGURES

The present invention is illustrated by way of example and not limitation in the Figures of the accompanying drawings in which:

FIG. 1 is a dataflow diagram illustrating dataflow and operations attended to remotely configuring a gaming machine;

FIG. 2 is a block diagram illustrating a gaming network, according to example embodiments of the invention;

FIG. 3 is a block diagram illustrating a configuration device, according to example embodiments of the invention;

FIG. 4 is a block diagram of a configuration server, according to example embodiments of the invention;

FIG. 5 is a block diagram illustrating components of a gaming machine, used in conjunction with example embodiments of the invention;

FIG. 6 is a perspective view of a gaming machine, according to example embodiments of the invention;

FIG. 7 is a flow diagram illustrating operations for acquiring gaming machine configuration settings and values, according to example embodiments of the invention;

FIG. 8 is a flow diagram illustrating operations for requesting configuration setting values for configuring a gaming machine, according to example embodiments of the invention; and

FIG. 9 is a flow diagram illustrating operations for remotely configuring a gaming machine, according to example embodiments of the invention;

FIG. 10 is a flow diagram illustrating operations for using a throttling mechanism and broadcast packets for reducing network traffic associated with configuring gaming machines in a gaming network, according to example embodiments of the invention; and

FIG. 11 is a flow diagram illustrating operations for reconfiguring gaming machines that include unapproved configurations, according to example embodiments of the invention.

### OVERVIEW OF SOME EMBODIMENTS

Systems, methods, and machine-readable media including instructions for a master control program for a gaming device are described herein. In one embodiment, an apparatus includes a presentation unit to present a graphical display of gaming machines, to receive a selection of one or more of the gaming machines, to present a set of configuration settings for the one or more gaming machines and to receive values for the set of configuration settings; and a configuration unit to obtain, based on the selection of one or more of the gaming machines, the set of configuration settings for the one or more gaming machines. In one embodiment, obtaining the set of configuration settings includes, transmitting the selection of the one or more gaming machines to a configuration server; and receiving the set of configuration settings from the configuration server. In one embodiment, the presentation unit includes a web browser. In one embodiment, the configuration unit is to obtain the configuration settings using wireless communication. In one embodiment, the graphical display of gaming machines is selected from the group consisting of a map layout of a casino floor, a list of gaming machines, and a table of gaming machines. In one embodiment, the values for the set of configuration settings include same values for each one of the one or more gaming machines.

In one embodiment, a computer-implemented method includes receiving configuration information associated with a gaming machine; based at least in part on the configuration information, determining a set of configuration settings; obtaining values for ones of the set of configuration settings; and transmitting the values for use in configuring the gaming machine. In one embodiment, the obtaining of the values includes, presenting a graphical representation of one or more gaming machines; receiving a selection of the gaming machine; presenting ones of the set of configuration settings; and receiving the values. In one embodiment, the obtaining of the values includes retrieving stored default values associated with the configuration settings. In one embodiment, the obtaining of the values includes determining the values based on a set of configuration rules. In one embodiment, the obtaining of the values includes interactively presenting the configuration settings to a human operator of the remote server. In one embodiment, the receiving of the configuration information includes reading portable memory medium. In one embodiment, the receiving of the configuration information includes receiving a transmission from the gaming machine, wherein the transmission includes the configuration information. In one embodiment, the determining of the configuration settings is also based on regulatory rules for a jurisdiction in which the specific gaming machine is located.

In one embodiment, a machine-readable medium including instructions which when executed by a gaming machine causes the machine perform operations comprising transmitting configuration information associated with the gaming machine; receiving values for configuration settings associated with the configuration information; and configuring the gaming machine based on the values. In one embodiment, the instructions which when executed by the gaming machine cause the machine to further perform operations comprising requesting a configuration server associated with the gaming machine; and receiving a response identifying a configuration server associated with the gaming machine. In one embodiment, the configuration information is selected from the group consisting of current game theme, gaming machine hardware, gaming machine software, gaming machine location, and current configuration settings. In one embodiment, the instructions which when executed by the gaming machine cause the machine to further perform operations comprising receiving a configuration script, wherein the configuring of the gaming machine based on the values includes executing the script. In one embodiment, the instructions which when executed by the gaming machine cause the machine to further perform operations comprising determining that the gaming machine needs to be configured. In one embodiment, the determining that the gaming machine needs to be configured is based on the gaming machine not being configured. In one embodiment, the determining that the gaming machine needs to be configured is based on the gaming machine being flagged to be configured.

In one embodiment, a method includes obtaining a gaming machine configuration information; creating a broadcast packet including the configuration information; transmitting the broadcast packet to gaming machines of a gaming network; receiving a number of broadcast packet receipt acknowledgments from ones of the gaming machines; waiting for a time period, the time period based at least in part on the number of broadcast packet receipt acknowledgments; and retransmitting the broadcast packet to the gaming machines of the gaming network. In one embodiment, the configuration information includes setting values. In one embodiment, the configuration information is obtained from a regulatory authority.

### DESCRIPTION OF THE EMBODIMENTS

Systems and methods for configuring gaming machines are described herein. This description of the embodiments is divided into five sections. The first section presents an introduction to embodiments of the invention, while the second section describes an example operating environment and system architecture. The third section describes example operations and the fourth section describes gaming machines in greater detail. The fifth section provides some general comments.

### Overview

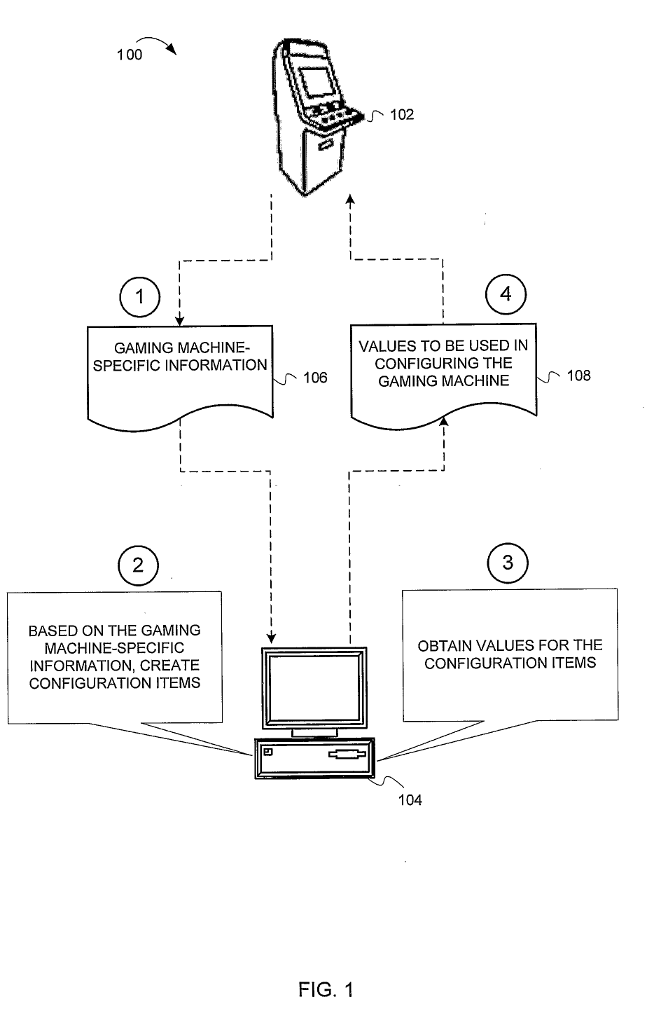

This section presents FIG. 1 as an introduction to a system for configuring gaming machines, according to embodiments of the invention.

FIG. 1 is a dataflow diagram illustrating dataflow and operations attendant to configuring a gaming machine, according to example embodiments of the invention. The dataflow diagram 100 shows four stages for configuring a gaming machine. Gaming machines can perform the operations of FIG. 1 when they are initially deployed onto a casino floor, when they receive configuration commands, or whenever configuration is otherwise desired.

At stage one, a gaming machine 102 transmits gaming machine-specific information 106 to a configuration server 104. The gaming machine-specific information 106 can include general information about the gaming machine's components. For example, the gaming machine-specific information 106 can include a list indicating that the gaming machine 102 includes a Brand X thirty-two inch plasma video screen, Bose speakers, Linux operating system, Brand Y bill validator, etc.

At stage two, the configuration server 104 determines what gaming machine settings should be configured based on the gaming machine-specific information 106. For example, the configuration server 104 may determine that the gaming machine's video screen resolution, video screen brightness, audio volume, network interface speeds, or other settings should be configured. The determination can be based at least in part on the gaming machine-specific information.

At stage three, the configuration server 104 obtains values for the machine settings that are to be configured. For example, the configuration server 104 learns that the gaming machine's video screen resolution should be set at 480×600, video screen brightness at “10”, audio volume at “7”, and network interface speed at “300 kbps.” The configuration server 104 can obtain these values from a technician through a user interface or from a database or other information source.

At stage four, the configuration server 104 transmits the setting values 108 to the gaming machine 102. After receiving the setting values 108, the gaming machine 102 can configure itself using the settings. Because embodiments of the invention enable gaming machines to automatically procure configuration settings over a network, the embodiments enable gaming machines to operate as plug-and-play devices.

### Example Gaming Network and System Architecture

This section provides an example gaming network in which embodiments of the invention can be practiced. This section also provides example architectures for a mobile configuration device, configuration server, and gaming machine. Operations for these and other embodiments will be described in the next section.

### Example Gaming Network

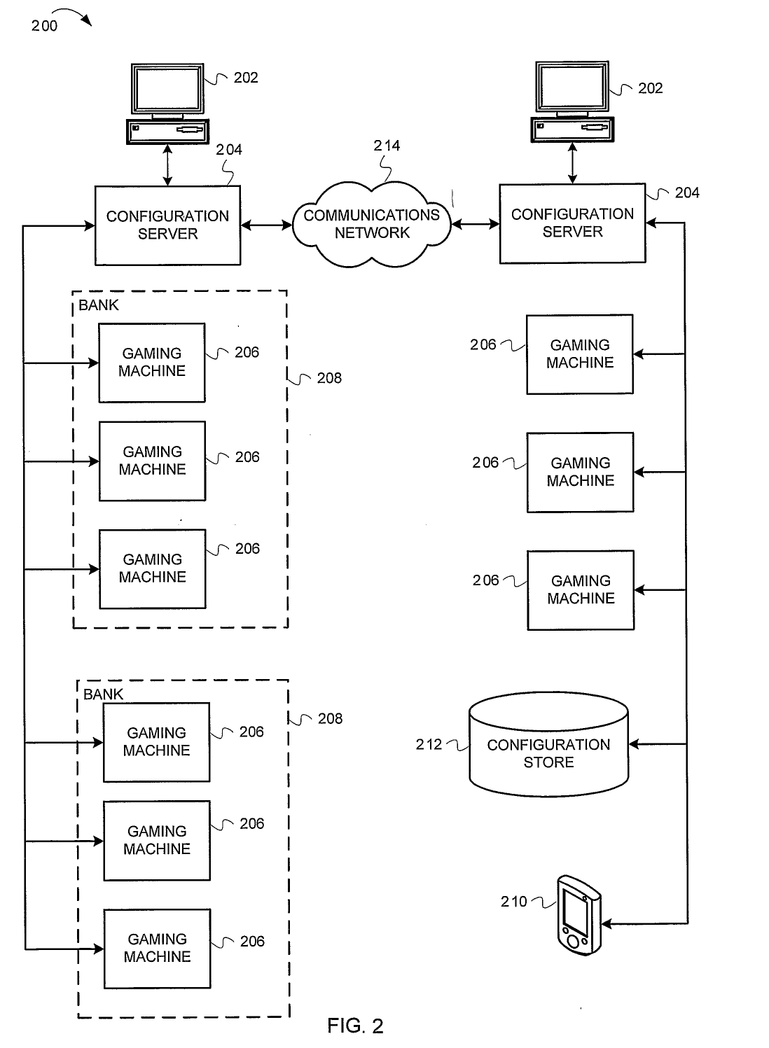

FIG. 2 is a block diagram illustrating a gaming network, according to example embodiments of the invention. As shown in FIG. 2, the gaming network 200 includes a plurality of configuration servers 204, each connected to a terminal 202. The configuration servers 204 are also connected to a communications network 214, which enables them to communicate with each other and with other computers (e.g., computers on the Internet).

Each configuration server 204 is connected to a plurality of gaming machines 206. The gaming machines 206 can be coupled in close physical proximity, forming banks 208. The gaming network 200 also includes a configuration store 212 and configuration device 210.

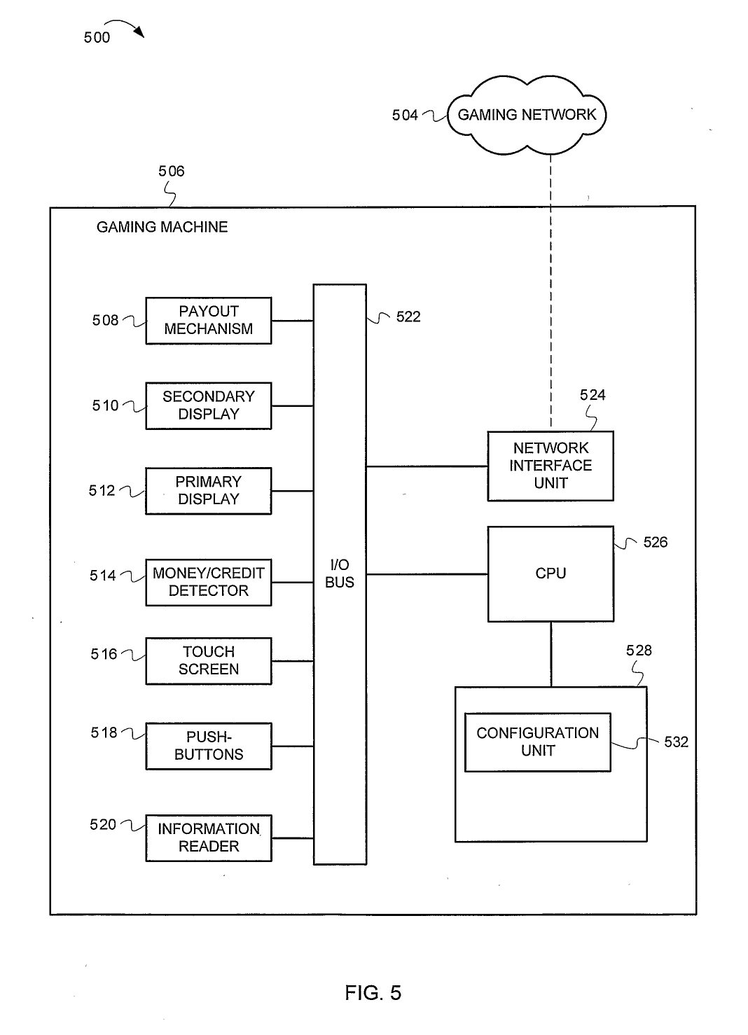

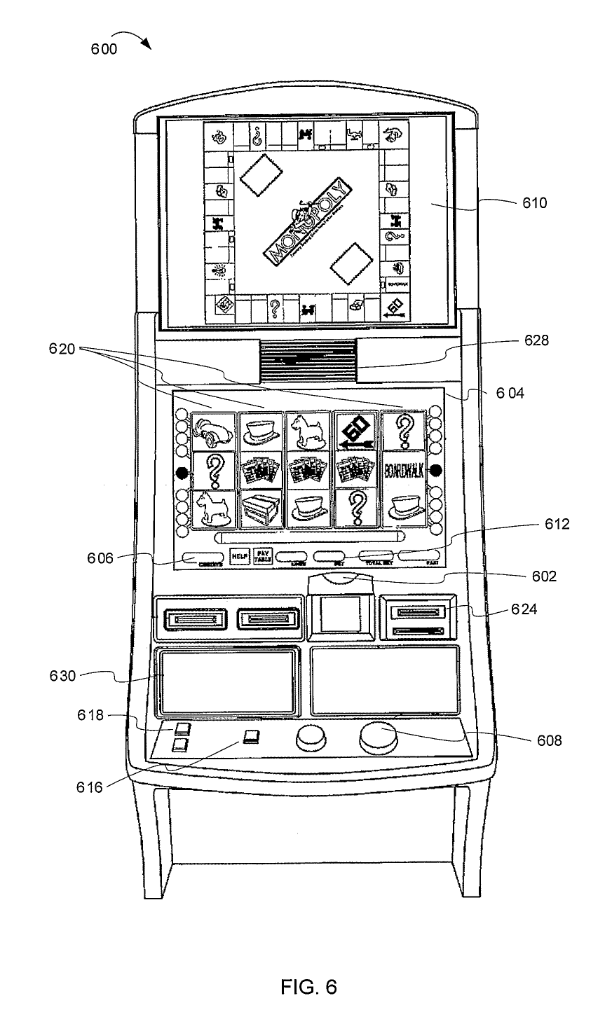

The gaming machines 206 can be any casino-style gaming machines for conducting casino-style wagering games, such as slots, blackjack, roulette, keno, poker, etc. In one embodiment, the gaming machines 206 can be automatically/remotely configured using information stored on or acquired by the configuration servers 204 and/or the configuration device 210. After the gaming machines 206 are configured, they can store their configuration settings on the configuration store 212; furthermore, the configuration store 212 can include a database of configuration information (i.e., configuration settings and/or configuration setting values) for initially configuring the gaming machines 206. Gaming machines are described in greater detail below, in the discussion of FIGS. 5 and 6.

The configuration servers 204 can determine configuration settings and configuration values for the gaming machines 206. In one embodiment, the configuration servers 204 can configure gaming machines in conjunction with the configuration device 210. For example, the configuration device 210 can wirelessly interact with the configuration servers 204 on a casino floor, allowing technicians to configure gaming machines while walking about the casino floor. The discussion continues with a more detailed description of configuration devices.

### Example Configuration Device

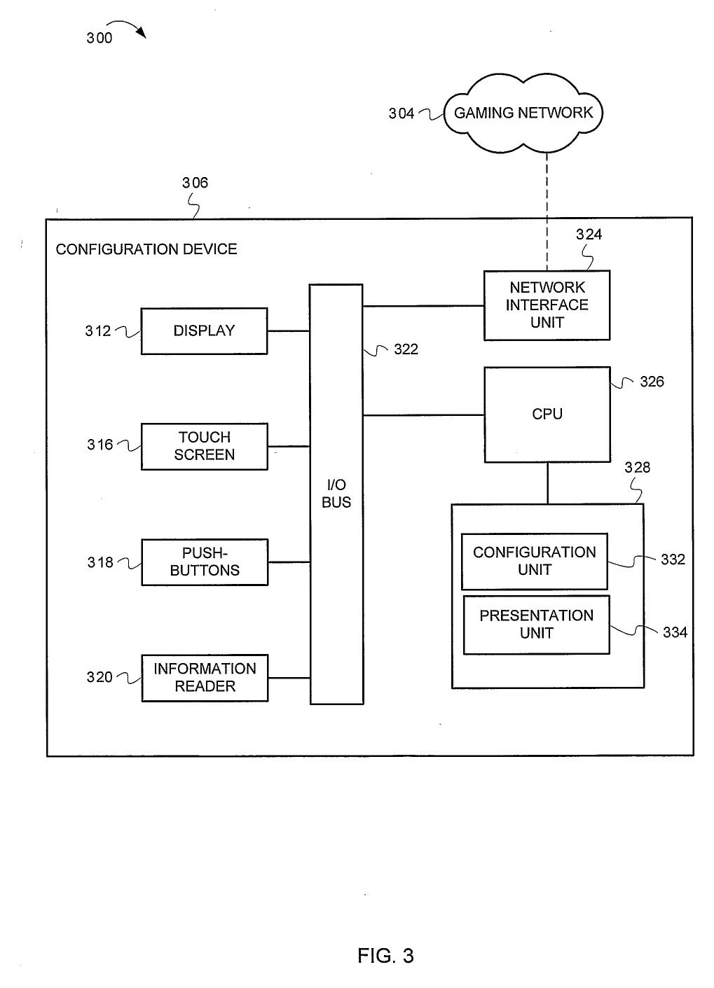

FIG. 3 is a block diagram illustrating a configuration device, according to example embodiments of the invention. The configuration device 306 can be any computing device capable of interfacing with a configuration server for configuring gaming machines. As such, the configuration device can be a desktop computer, laptop computers, personal digital assistant (PDA), or other suitable computing device. In one embodiment, a gaming machine can be set-up to operate as a configuration device 306. In another embodiment, the configuration device 306 can be a hand-held wireless device, much like a PDA or cellular telephone.

As shown in FIG. 3, the configuration device 306 can include an input/output (I/O) bus 322, which is connected to a central processing unit (CPU) 326. The CPU 326 is connected to a memory unit 328, which includes a configuration unit 332 and a presentation unit 334. The I/O bus 322 is also connected to display unit 312, touchscreen 316, push buttons 318, information reader 320, and network interface unit 324. The network interface unit 324 can connect to any suitable wireless or wired network.

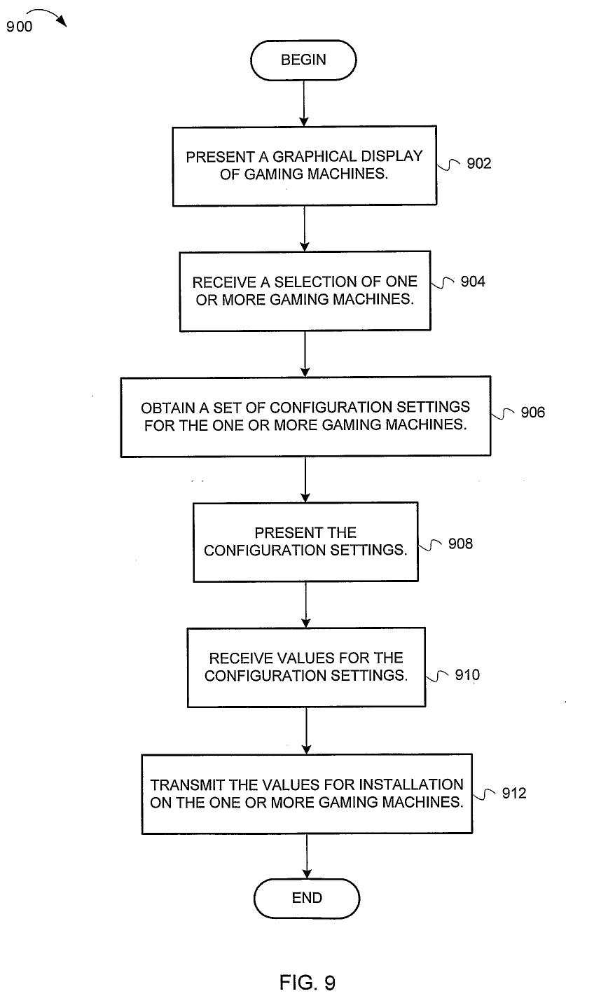

The presentation unit 334 can present and receive gaming machine configuration choices through a graphical user interface, which is presented on the display 312. The configuration unit 332 can determine configuration settings based on configuration information received through the network interface unit 324 from devices on the gaming network 304 (e.g., the configuration server 204). Example operations of a configuration device are described below, in the discussion of FIG. 9. This description continues with a more detailed discussion of a configuration server.

### Example Configuration Server

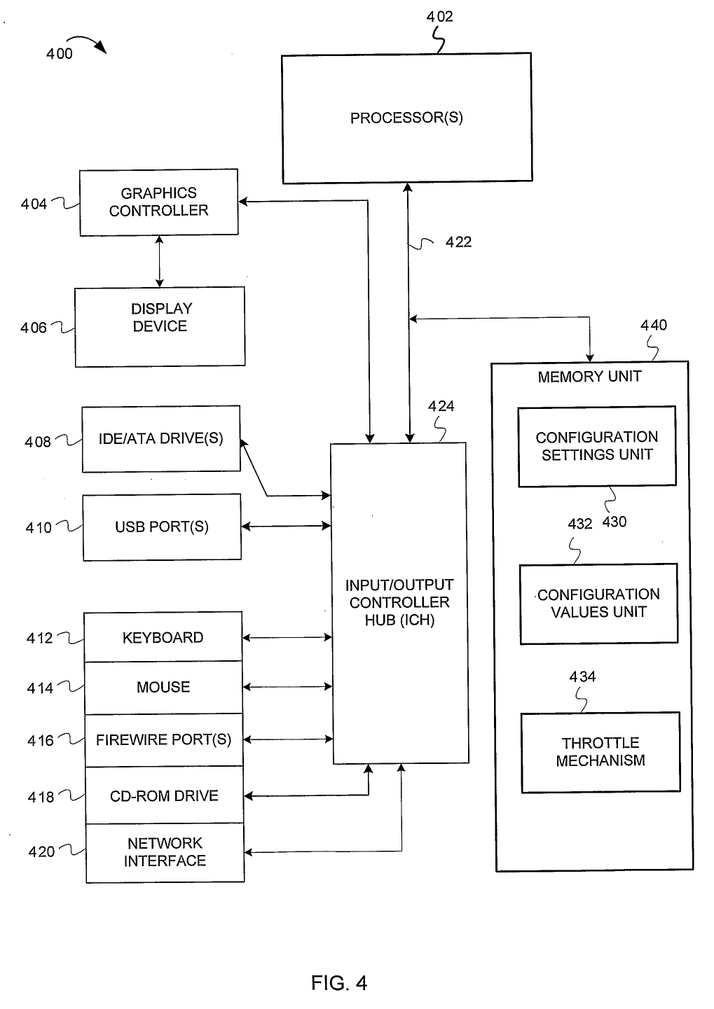

FIG. 4 is a block diagram of a configuration server, according to example embodiments of the invention. As illustrated in FIG. 4, the configuration server 400 comprises processor(s) 402. The configuration server 400 also includes a memory unit 440, processor bus 422, and Input/Output controller hub (ICH) 424. The processor(s) 402, memory unit 440, and ICH 424 are coupled to the processor bus 422. The processor(s) 402 may be of any suitable processor architecture. The configuration server 400 may comprise one, two, three, or more processors, any of which can execute a set of instructions in accordance with embodiments of the invention.

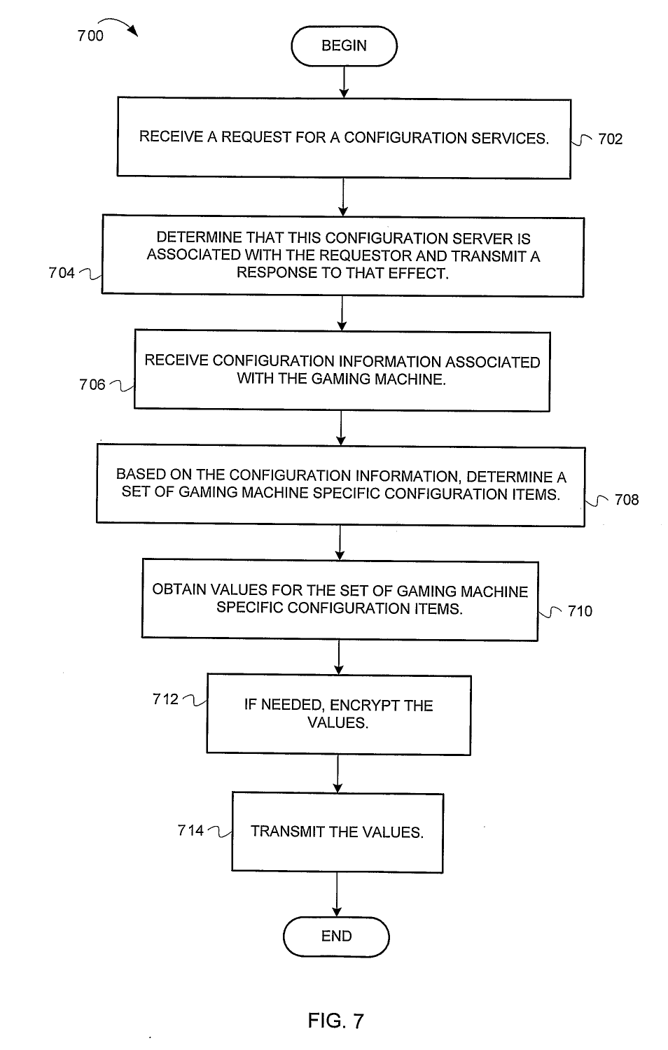

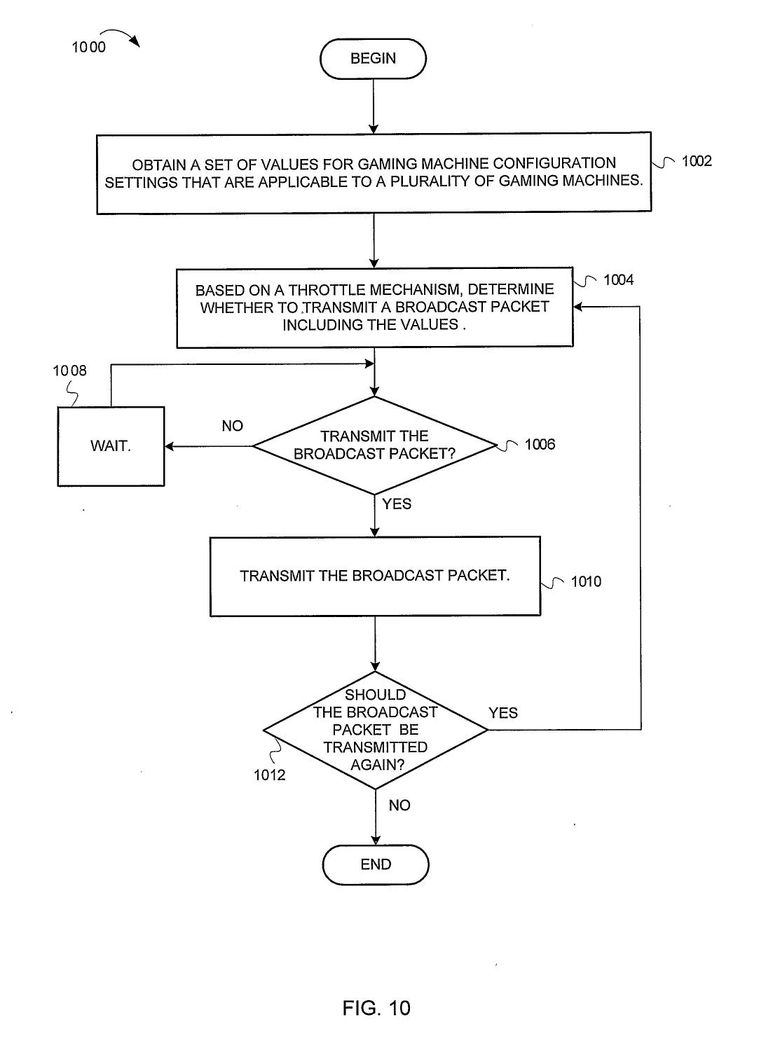

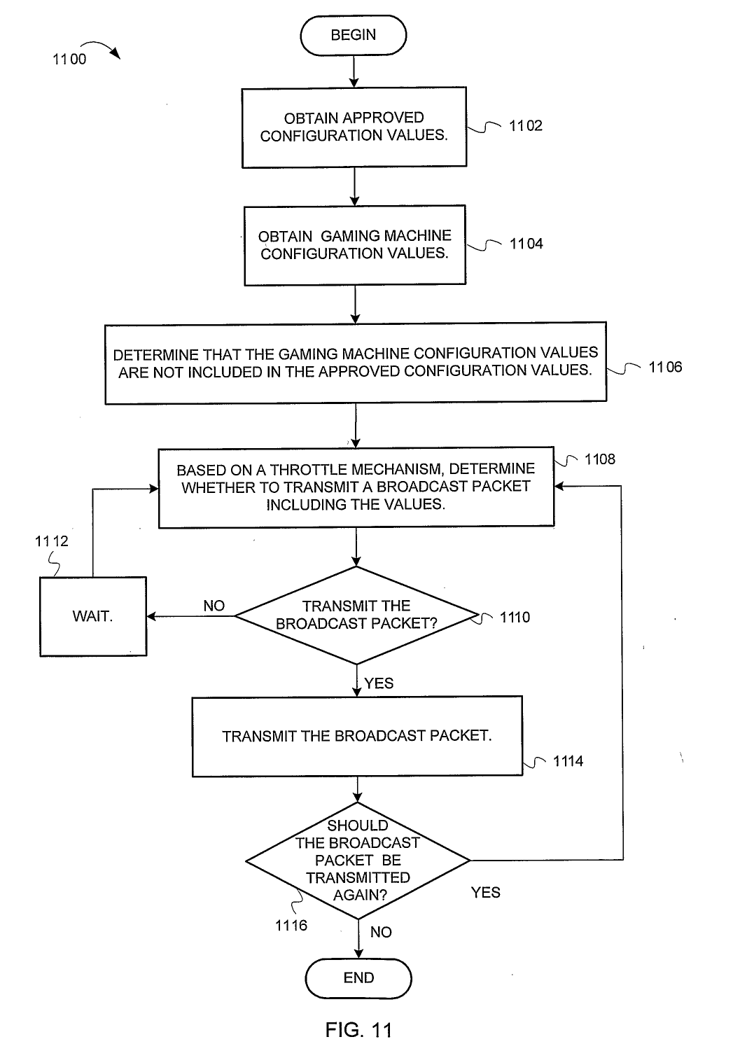

The memory unit 440 includes a configuration settings unit 430, configuration values unit 432, and throttle mechanism 434. The configuration settings unit 430 can determine configuration settings for gaming machine components, while the configuration values unit 432 can determine values for the configuration settings. The throttle mechanism can increase or reduce a frequency for transmitting configuration information over a gaming network. Operations for embodiments of the configuration settings unit 430 and the configuration values unit 432 are described in greater detail below, in the discussion of FIG. 7. Operations performed by embodiments of the throttle mechanism 434 are described below, in the discussion of FIGS. 10 and 11. The memory unit 440 can also store data and/or instructions, and can comprise any suitable memory, such as a dynamic random access memory (DRAM). The configuration server 400 also includes IDE drive(s) 408 and/or other suitable storage devices. A graphics controller 404 controls the display of information on a display device 406, according to embodiments of the invention.

The input/output controller hub (ICH) 424 provides an interface to I/O devices or peripheral components for the configuration server 400. The ICH 424 may comprise any suitable interface controller to provide for any suitable communication link to the processor(s) 402, memory unit 440 and/or to any suitable device or component in communication with the ICH 424. For one embodiment of the invention, the ICH 424 provides suitable arbitration and buffering for each interface.

For one embodiment of the invention, the ICH 424 provides an interface to one or more suitable integrated drive electronics (IDE) drives 408, such as a hard disk drive (HDD) and to suitable universal serial bus (USB) devices through one or more USB ports 410. For one embodiment, the ICH 424 also provides an interface to a keyboard 412, mouse 414, CD-ROM drive 418, or other suitable devices through one or more firewire ports 416. In one embodiment, the ICH 424 also provides a network interface 420 though which the configuration server 400 can communicate with gaming machines, configuration devices, and other gaming network devices. The network interface 420 can employ any suitable wireless technology (e.g., 802.11b, 802.11g, etc.) for wirelessly connecting to gaming networks.

In one embodiment, the configuration server 400 includes a machine-readable medium that stores a set of instructions (e.g., software) embodying any one, or all, of the methodologies for configuring gaming machines, as described herein. Furthermore, software can reside, completely or at least partially, within memory unit 440 and/or within the processor(s) 402. This description continues with a discussion of example gaming machines.

### Example Gaming Machines

FIG. 5 is a block diagram illustrating components of a gaming machine, used in conjunction with example embodiments of the invention. As shown in FIG. 5, the gaming machine 506 includes a central processing unit (CPU) 526 connected to a memory unit 528, which includes a configuration unit 532. In one embodiment, the configuration unit 532 receives configuration settings and/or values and configures the gaming machine 506 for operation in a gaming network. The CPU 526 is also connected to a network interface unit 524, which is connected to a gaming network 504. The CPU 526 is also connected to an input/output (I/O) bus 522. The I/O bus 522 is connected to a payout mechanism 508, secondary display 510, primary display 512, money/credit detector 514, touchscreen 516, push-buttons 518, and information reader 520. The I/O bus 522 facilitates communication between the system components and the CPU 526.

According to some embodiments, the gaming machine 506 can include additional peripheral devices and/or more than one of each component shown in FIG. 5. For example, in one embodiment, the gaming machine 506 can include multiple network interface units 524 and multiple CPUs 526. Additionally, the components of the gaming machine 506 can be interconnected according to any suitable interconnection architecture (e.g., directly connected, hypercube, etc.).

According to some embodiments, the gaming machine 506 includes tangible machine-readable media including instructions for conducting basic wagering games, conducting bonus games, and configuring gaming machines. According to embodiments of the invention, the gaming machine 506 and other components of the gaming network can include other types of logic (e.g., digital logic) for executing the operations described herein.

According to embodiments, the gaming machine 506 can conduct any suitable casino-style wagering game, such as video poker, video blackjack, video slots, etc. Additional details about gaming machines used in conjunction with embodiments of the invention are described below, in the discussion of FIG. 6.

FIG. 6 is a perspective view of a gaming machine, according to example embodiments of the invention. As shown in FIG. 6, the gaming machine 600 can be a computerized slot machine having the controls, displays, and features of a conventional slot machine.

The gaming machine 600 can be operated while players are standing or seated. Additionally, the gaming machine 600 is preferably mounted on a stand (not shown). However, it should be appreciated that the gaming machine 600 can be constructed as a pub-style tabletop game (not shown), which a player can operate while sitting. Furthermore, the gaming machine 600 can be constructed with varying cabinet and display designs. The gaming machine 600 can incorporate any primary game such as slots, poker, or keno, and additional bonus round games. The symbols and indicia used on and in the gaming machine 600 can take mechanical, electrical, or video form.

As illustrated in FIG. 6, the gaming machine 600 includes a coin slot 602 and bill acceptor 624. Players can place coins in the coin slot 602 and paper money or ticket vouchers in the bill acceptor 624. Other devices can be used for accepting payment. For example, credit/debit card readers/validators can be used for accepting payment. Additionally, the gaming machine 600 can perform electronic funds transfers and financial transfers to procure monies from financial accounts. When a player inserts money in the gaming machine 600, a number of credits corresponding to the amount deposited are shown in a credit display 606. After depositing the appropriate amount of money, a player can begin playing the game by pushing play button 608. The play button 608 can be any play activator used for starting a wagering game or sequence of events in the gaming machine 600.

As shown in FIG. 6, the gaming machine 600 also includes a bet display 612 and a “bet one” button 616. The player places a bet by pushing the bet one button 616. The player can increase the bet by one credit each time the player pushes the bet one button 616. When the player pushes the bet one button 616, the number of credits shown in the credit display 606 decreases by one credit, while the number of credits shown in the bet display 612 increases by one credit.

A player may “cash out” by pressing a cash out button 618. When a player cashes out, the gaming machine 600 dispenses a voucher or currency corresponding to the number of remaining credits. The gaming machine 600 may employ other payout mechanisms such as credit slips (which are redeemable by a cashier) or electronically recordable cards (which track player credits), or electronic funds transfer.

The gaming machine also includes a primary display unit 604 and a secondary display unit 610 (also known as a “top box”). The gaming machine may also include an auxiliary video display 630. In one embodiment, the primary display unit 604 displays a plurality of video reels 620. According to embodiments of the invention, the display units 604 and 610 can include any visual representation or exhibition, including moving physical objects (e.g., mechanical reels and wheels), dynamic lighting, and video images. In one embodiment, each reel 620 includes a plurality of symbols such as bells, hearts, fruits, numbers, letters, bars or other images, which correspond to a theme associated with the gaming machine 600. Furthermore, as shown in FIG. 6, the gaming machine 600 includes a audio presentation unit 628. The audio presentation unit 628 can include audio speakers or other suitable sound projection devices.

In one embodiment, the gaming machine 600 can receive configuration settings/values through a gaming network, as described herein.

### System Operations

This section describes operations performed by embodiments of the invention. In the discussion below, the flow diagrams will be described with reference to the block diagrams presented above. In certain embodiments, the operations are performed by instructions residing on machine-readable media (e.g., software), while in other embodiments, the operations are performed by hardware and/or other logic (e.g., digital logic). The description continues with FIG. 7.

FIG. 7 is a flow diagram illustrating operations for acquiring gaming machine configuration settings and values, according to example embodiments of the invention. In one embodiment, the operations of flow diagram 700 are performed by a configuration server, while in other embodiments, the operations can be performed by other gaming network devices. The flow diagram 700 commences at block 702.

At block 702, a configuration server 204 receives from a gaming machine 206 a request for configuration services. In one embodiment, the gaming machine 206 desires services from a configuration server 204 that is within close proximity or otherwise associated with the gaming machine 206. The flow continues at block 704.

At block 704, the configuration server 204 determines that it is associated with the gaming machine 206 and transmits a response to that effect. Some configuration servers of a gaming network may receive service requests and determine that they will not provide services to the requestor. However, in one embodiment, at least one configuration server 204 is associated with the gaming machine 206. The flow continues at block 706.

At block 706, the configuration server 204 receives configuration information associated with the gaming machine 206. In one embodiment, the configuration information includes general information about a gaming machine's components. For example, the gaming machine-specific information 106 can include a list indicating that the gaming machine 102 includes a Brand X thirty-two inch plasma video screen, Bose speakers, Linux operating system, Brand Y bill validator, etc. The configuration information can also include information about a wagering game (e.g., title, version, and jurisdiction). In one embodiment, the configuration information is even more general. For example, the configuration information may only indicate what type of wagering game is on the gaming machine 206. The flow continues at block 708.

At block 708, the configuration server's configuration settings unit 430 determines, based on the configuration information, a set of the gaming machine's settings that are to be configured. For example, the configuration server 204 may determine that the gaming machine's video screen resolution, video screen brightness, audio volume, network interface speeds, or other settings should be configured.

In one embodiment, the configuration settings unit 430 consults a database (e.g., the configuration store 212) or other data source to determine settings associated with the configuration information. The configuration settings unit 430 can also employ an algorithm, rules, or other logic for determining the configuration settings based on the configuration information. In one embodiment, the rules/algorithm enables the configuration settings unit 430 to select different settings based on regulatory jurisdictions in which the gaming machine is located. The flow continues at block 710.

At block 710, the configuration server's configuration values unit 432 obtains values for the set of gaming machine's settings. In one embodiment, the configuration value unit 432 obtains the values from a technician through a graphical user interface. In another embodiment, the configuration value unit 432 obtains the values from a compact disc in the CD-ROM drive 418. In yet another embodiment, the configuration values unit 432 obtains the configuration values from a database (remote or local) or other data source (e.g., semiconductor memory device, flat file data store, etc.). Alternatively, the configuration value unit 432 can employ an algorithm, rules, or other logic for determining values for configuration settings determined at block 708. The flow continues at block 712.

At block 712, the configuration server 204 encrypts the values, if needed. In one embodiment, the configuration server encrypts the values using an encryption key specific to a particular regulatory jurisdiction. For example, when the configuration server 204 transmits configuration values to gaming machines in Las Vegas, it encrypts the values with a Nevada-specific encryption key. The flow continues at block 714.

At block 714, the configuration server 204 transmits the values to the gaming machine 206. In one embodiment, the configuration server 204 may transmit scripts and/or application programs that automatically configure the gaming machine 204 according to the configuration values. In one embodiment, the configuration server 204 may transmit the values to a database (e.g., the configuration store 212), which in turn forwards the configuration values on to the gaming machine 206. From block 714, the flow ends.

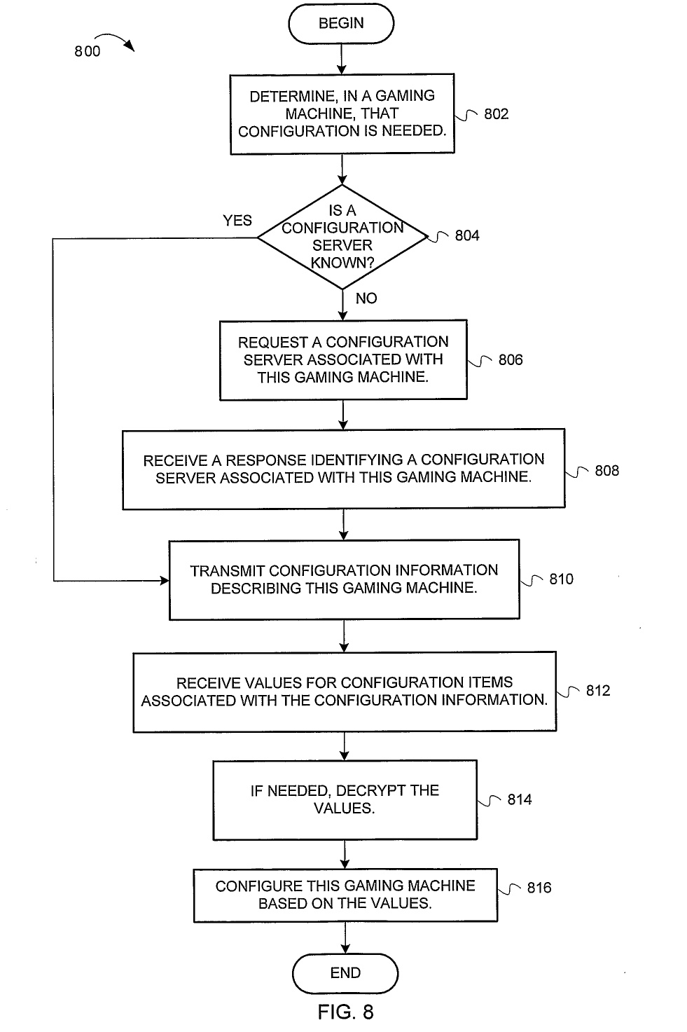

While FIG. 7 describes operations for determining and transmitting configuration values, FIG. 8 describes operations for requesting the configuration values and using them for configuring a gaming machine.

FIG. 8 is a flow diagram illustrating operations for requesting configuration setting values for configuring a gaming machine, according to example embodiments of the invention. In one embodiment, the flow diagram 800 is performed by a gaming machine. In other embodiments, other gaming network devices can perform the operations of flow 800. The flow diagram 800 commences at block 802.

At block 802, a gaming machine's configuration unit 532 determines that it needs to be configured. In one embodiment, the configuration unit 532 determines that the gaming machine 206 needs to be configured when it is connected to a new gaming network or when it receives a configuration command from a gaming network device. The flow continues at block 804.

At block 804, the gaming machine's configuration unit 532 determines whether there is a known configuration server. If the gaming machine's configuration unit 532 knows of a configuration server, the flow continues at block 810. Otherwise, the flow continues at block 806.

At block 806, the gaming machine 206 broadcasts requests for configuration services to all configuration servers 204 on the gaming network 200. The flow continues at block 808.

At block 808, the gaming machine 206 receives a response identifying a configuration server 204 that is associated with the gaming machine 206. The flow continues at block 810.

At block 810, the gaming machine 206 transmits configuration information to the configuration server 204. As noted above, the configuration information can include general information about a gaming machine's components. The flow continues at block 812.

At block 812, the gaming machine 206 receives from the configuration server 204 values for configuration settings of the gaming machine's components. In one embodiment, the gaming machine 206 also receives scripts and/or application programs for configuring the gaming machine 206 according to the values. The flow continues at block 814.

At block 814, the gaming machine 206 decrypts the values, if needed. In one embodiment, if the values have been encrypted, the gaming machine 206 decrypts the values with an appropriate security key. In one embodiment, the key is associated with a particular regulatory jurisdiction or agency. The flow continues at block 816.

At block 816, the gaming machine 206 configures itself based on the values. In one embodiment, the configuration unit 532 configures the gaming machine's components (including software for performing wagering games) according to the setting values received from the configuration server 204. In another embodiment, in order to configure the gaming machine 206, the configuration unit 532 launches application programs and/or scripts received from the configuration server 204. From block 816, the flow ends.

This description continues with a discussion of operations for configuring gaming machines using a configuration device, such as a handheld wireless computer. The discussion continues with FIG. 9.

FIG. 9 is a flow diagram illustrating operations for remotely configuring a gaming machine, according to example embodiments of the invention. In one embodiment, the operations of the flow diagram 900 are to be performed by a mobile configuration device. However, the flow 900 can also be performed by a gaming machine or other gaming network component. The flow diagram 900 commences at block 902.

At block 902, the configuration device's presentation unit 334 presents a graphical display of gaming machines on its display 312. In one embodiment, the graphical display represents a topological layout of gaming machines on a casino floor or in a wide area gaming network. The flow continues at block 904.

At block 904, the configuration device 306 receives a selection of one or more gaming machines from those presented on the display 312. The flow continues at block 906.

At block 906, the configuration device's configuration unit 332 obtains a set of configuration settings for the selected gaming machine(s). In one embodiment, the configuration unit 332 obtains the configuration settings by receiving menu selections through graphical user interface or by querying a database or other data source (e.g. a flash memory card). The configuration unit 332 can acquire the configuration settings from web pages stored on gaming network devices (e.g., configuration servers). As described above, the configuration settings indicate certain configurable features associated with the gamine machine components. For example, configuration settings can include a gaming machine's video screen resolution, video screen brightness, audio volume, network interface speeds, and any other configurable settings. The flow continues at block 908.

At block 908, the presentation unit 334 presents the configuration settings. In one embodiment, the configuration device 306 presents the configuration settings in a graphical user interface on the display 312. In another embodiment, the presentation unit 334 presents (i.e., transmits) the configuration settings to a configuration server 204. The flow continues at block 910.

At block 910, the configuration device's configuration unit 332 receives values for the configuration settings. In one embodiment, the configuration device 306 receives the values through graphical user interface. In another embodiment, the configuration device 306 receives the values from the configuration server 204 or other network device. The flow continues at block 912.

At block 912, the configuration device 306 transmits the configuration values for installation on the selected gaming machine(s). After the gaming machine receives the configuration values, the gaming machine can configure itself according to the configuration values. From block 912, the flow ends.

This description continues with a discussion of FIGS. 10 and 11. FIGS. 10 and 11 describe operations for automatically sending configuration information over the gaming network to large groups of gaming machines while keeping network traffic and communication overhead relatively low.

FIG. 10 is a flow diagram illustrating operations for using a throttling mechanism and broadcast packets for reducing network traffic associated with configuring gaming machines in a gaming network, according to example embodiments of the invention. It may be desirable for the configuration server 204 to configure all gaming machines of a particular gaming network. As a result, the configuration server 204 can use broadcast packets for configuring all the gaming machines of the network, where each broadcast packet includes any necessary configuration information. In one embodiment, a single broadcast packet will be transmitted to and processed by every gaming machine on a gaming network. Using broadcast packets reduces communication overhead because they eliminate a need for creating and transmitting different unicast packets to each gaming machine on the network. The flow 1000 commences at block 1002.

At block 1002, a configuration server 204 obtains a set of values for gaming machine configuration settings that are applicable to a group of gaming machines (e.g. all gaming machines in a network). In another embodiment, the configuration server 204 can obtain any other suitable configuration information. The flow continues at block 1004.

At block 1004, the configuration server's throttle mechanism 434 determines whether to transmit a broadcast packet including the configuration setting values. In one embodiment, the configuration server 204 will periodically transmit broadcast packets that include configuration information until all gaming machines acknowledge receipt of the configuration information. As more gaming machines acknowledge receipt of the broadcast packet (and thus the values), the throttle mechanism 434 can reduce the frequency with which it periodically transmits the broadcast packets. As a result, the configuration server 204 can reduce network traffic associated with configuring gaming machines on the gaming network 200. The remaining operations of the flow 1000 describe the throttling process. The flow continues at block 1006.

At block 1006, if it is time to transmit the broadcast packet, the flow continues at block 1010. Otherwise, the flow continues at block 1008.

At block 1008, the throttle mechanism 434 waits for a period of time and proceeds to block 1006.

At block 1010, the configuration server 204 transmits the broadcast packet including the configuration values. The flow continues at block 1012.

At block 1012, the throttle mechanism 434 determines whether the broadcast packet should be transmitted again. For example, the throttle mechanism 434 determines whether all gaming machines 206 on the gaming network 200 have confirmed receipt of the broadcast packet. If the broadcast packet should be transmitted again, the flow continues at block 1004. Otherwise, the flow ends.

FIG. 11 is a flow diagram illustrating operations for reconfiguring gaming machines that include unapproved configurations, according to example embodiments of the invention. The flow 1100 commences at block 1102.

At block 1102, the configuration server 204 obtains approved configuration values. For example, the configuration server 204 can obtain approved wagering game pay table values, denominations, and other settings from a wagering gaming regulatory authority (e.g., the Nevada Gaming Commission). The flow continues at block 1104.

At block 1104, the configuration server 204 obtains configuration values for the gaming machines of the network. In one embodiment, the configuration server 204 receives data packets including the gaming machines' configuration values. The flow continues at block 1106.

At block 1106, the configuration server 204 determines that the gaming machine configuration values are not included in the approved configuration values. The flow continues as shown in FIG. 11. Because the remaining operations of the flow 1100 are similar to those of the flow 1000 of FIG. 10, the operations will not be explicitly described. In one embodiment, the operations of the flow 1100 enable automatic reconfiguration of gaming machines that include unapproved or illegal configuration settings. In one embodiment, the broadcast packets include configuration information that will reconfigure gaming machines differently, depending on the regulatory jurisdiction in which they reside. For example, the configuration information can cause gaming machines in Nevada to use one pay table, while causing gaming machines in Australia to use another pay table. The flow 1100 can enable configuration servers to automatically reconfigure gaming machines to comply with newly passed regulatory requirements.

### General

In this description, numerous specific details are set forth. However, it is understood that embodiments of the invention may be practiced without these specific details. In other instances, well-known circuits, structures and techniques have not been shown in detail in order not to obscure the understanding of this description. Note that in this description, references to “one embodiment” or “an embodiment” mean that the feature being referred to is included in at least one embodiment of the invention. Further, separate references to “one embodiment” in this description do not necessarily refer to the same embodiment; however, neither are such embodiments mutually exclusive, unless so stated and except as will be readily apparent to those of ordinary skill in the art. Thus, the present invention can include any variety of combinations and/or integrations of the embodiments described herein. Each claim constitutes an embodiment of the invention, and is incorporated by reference into the detailed description. Moreover, in this description, the phrase “exemplary embodiment” means that the embodiment being referred to serves as an example or illustration.

Herein, block diagrams illustrate exemplary embodiments of the invention. Also herein, flow diagrams illustrate operations of the exemplary embodiments of the invention. The operations of the flow diagrams are described with reference to the exemplary embodiments shown in the block diagrams. However, it should be understood that the operations of the flow diagrams could be performed by embodiments of the invention other than those discussed with reference to the block diagrams, and embodiments discussed with references to the block diagrams could perform operations different than those discussed with reference to the flow diagrams. Additionally, some embodiments may not perform all the operations shown in a flow diagram.

Although the flow diagrams depict serial operations, certain embodiments could perform certain of those operations in parallel. Additionally, although data is described herein as being transmitted from one device to another, the data can flow through any number of intermediate devices before arriving at the described destination.

1. An apparatus comprising:
a presentation unit to present a graphical display of gaming machines, to receive a selection of one or more of the gaming machines, to present a set of configuration settings for the one or more gaming machines and to receive values for the set of configuration settings; and
a configuration unit to obtain, based on the selection of one or more of the gaming machines, the set of configuration settings for the one or more gaming machines.

2. The apparatus of claim 1, wherein obtaining the set of configuration settings includes,
transmitting the selection of the one or more gaming machines to a configuration server; and
receiving the set of configuration settings from the configuration server.

3. The apparatus of claim 1, wherein the presentation unit includes a web browser.

4. The apparatus of claim 1, wherein the configuration unit is to obtain the configuration settings using wireless communication.

5. The apparatus of claim 1, wherein the graphical display of gaming machines is selected from the group consisting of a map layout of a casino floor, a list of gaming machines, and a table of gaming machines.

6. The apparatus of claim 1, wherein the values for the set of configuration settings include same values for each one of the one or more gaming machines.

7. A computer-implemented method comprising:
receiving configuration information associated with a gaming machine;
based at least in part on the configuration information, determining a set of configuration settings;
obtaining values for ones of the set of configuration settings; and
transmitting the values for use in configuring the gaming machine.

8. The computer-implemented method of claim 7, wherein the obtaining of the values includes,
presenting a graphical representation of one or more gaming machines;
receiving a selection of the gaming machine;
presenting ones of the set of configuration settings; and
receiving the values.

9. The computer-implemented method of claim 7, wherein the obtaining of the values includes retrieving stored default values associated with the configuration settings.

10. The computer-implemented method of claim 7, wherein the obtaining of the values includes determining the values based on a set of configuration rules.

11. The computer-implemented method of claim 7, wherein the obtaining of the values includes interactively presenting the configuration settings to a human operator of the remote server.

12. The computer-implemented method of claim 7, wherein the receiving of the configuration information includes reading portable memory medium.

13. The computer-implemented method of claim 7, wherein the receiving of the configuration information includes receiving a transmission from the gaming machine, wherein the transmission includes the configuration information.

14. The computer-implemented method of claim 7, wherein the determining of the configuration settings is also based on regulatory rules for a jurisdiction in which the specific gaming machine is located.

15. A machine-readable medium including instructions which when executed by a gaming machine cause the machine perform operations comprising:
transmitting configuration information associated with the gaming machine;
receiving values for configuration settings associated with the configuration information; and
configuring the gaming machine based on the values.

16. The machine-readable medium of claim 15, wherein the instructions which when executed by the gaming machine cause the machine to further perform operations comprising:
requesting a configuration server associated with the gaming machine; and
receiving a response identifying a configuration server associated with the gaming machine.

17. The machine-readable medium of claim 15, wherein the configuration information is selected from the group consisting of current game theme, gaming machine hardware, gaming machine software, gaming machine location, and current configuration settings.

18. The machine-readable medium of claim 15, wherein the instructions which when executed by the gaming machine cause the machine to further perform operations comprising:
receiving a configuration script, wherein the configuring of the gaming machine based on the values includes executing the script.

19. The machine-readable medium of claim 15, wherein the instructions which when executed by the gaming machine cause the machine to further perform operations comprising:
determining that the gaming machine needs to be configured.

20. The machine-readable medium of claim 19, wherein the determining that the gaming machine needs to be configured is based on the gaming machine not being configured.

21. The machine-readable medium of claim 19, wherein the determining that the gaming machine needs to be configured is based on the gaming machine being flagged to be configured.

22. A method comprising:
obtaining a gaming machine configuration information;
creating a broadcast packet including the configuration information;
transmitting the broadcast packet to gaming machines of a gaming network;
receiving a number of broadcast packet receipt acknowledgments from ones of the gaming machines;
waiting for a time period, the time period based at least in part on the number of broadcast packet receipt acknowledgments; and
retransmitting the broadcast packet to the gaming machines of the gaming network.

23. The method of claim 22, wherein the configuration information includes setting values.

24. The method of claim 22, wherein the configuration information is obtained from a regulatory authority.
